(19) United States
(12) Patent Application Publication
(10) Pub. No.: US 2008/0060059 A1
(43) Pub. Date: Mar. 6, 2008

(54) DATA PROCESSOR, PERIPHERAL DEVICE, AND RECORDING MEDIUM USED HEREWITH

(76) Inventor: Takuya Yoshida, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/850,421

(22) Filed: Sep. 5, 2007

(30) Foreign Application Priority Data
Sep. 5, 2006 (JP) 2006-240390

(51) Int. Cl. H04L 9/32

(52) U.S. Cl. 726/4

(57) ABSTRACT

A data processor connected to a peripheral device via a network includes an interceptor, a controller, and a peripheral device manager. The interceptor intercepts an access request for data stored in the peripheral device to issue a message indicating the interception and transmit the access request to the peripheral device. The controller determines, upon receipt of the message from the interceptor, whether to perform authentication based on configuration information of the peripheral device. Additionally, the controller determines, when authentication is to be performed, a mode for obtaining authentication data depending on whether an authentication library is installed. The peripheral device manager retrieves the configuration information from the peripheral device and transmits the configuration information to the controller.

### CROSS-REFERENCE TO RELATED APPLICATIONS

The present patent application claims priority under 35 U.S.C. §119 from Japanese Patent Application No. 2006-240390 filed on Sep. 5, 2006 in the Japanese Patent Office, the contents of which are hereby incorporated by reference herein in their entirety.

### BACKGROUND OF THE INVENTION

1. Field of the Invention

The present invention relates to a data processor, a peripheral device, and a recording medium used herewith, and more particularly, to a data processor and a peripheral device capable of performing authentication by executing a computer program stored on a recording medium.

2. Discussion of the Related Art

Users of a computer network can access peripheral devices through a data processor executing an application program, and with a growing need for information security an application user is required to be authenticated when accessing important information stored in a particular peripheral device, such as personal information about enterprise customers and/or employees. Therefore, various methods and apparatuses have been developed to provide an authentication system that allows an application user to access information using a data processor.

For example, one conventional authentication method uses biometrics identification in conjunction with a public key cryptosystem to identify an individual user.

Further, another conventional method provides authentication with a given level of accuracy for user identification. In this method, an authentication system includes a storage unit for retaining information on registered users, a first module for capturing information of an individual user, and a second module for acquiring information of a desired accuracy level. The system performs authentication by comparing the registered user information and the captured user information in accordance with the desired accuracy level.

Still further, another conventional method provides authentication through different authentication devices. In this method, an authentication system includes a controller and multiple authentication devices. The controller selects one of the multiple authentication devices based on given information and causes the selected device to acquire authentication data.

Furthermore, another conventional method provides protection against unauthorized access based on a given threshold level. In this method, an authentication system includes a storage unit for retaining identity information of a user, a first controller for modifying the identity information, and a second controller for determining whether to permit access based on the identity information and a given security level.

Additionally, another conventional method provides authentication for multiple applications running on a data processor. In this method, the data processor manages authentication data entered by a user attempting to access an application in relation to information on the application and information on an authentication module providing an authentication capability.

Typically, an authentication system requires a user to provide authentication information including a user identifier and a password to a data processor connected to a peripheral device. Depending on the type of peripheral device and application running on the data processor, input of such information may be needed each time the user requests access to the peripheral device. In acquiring authentication information, a conventional data processor displays a dialog box that prompts a user to manually enter the required information.

The manual entry process is burdensome and, when repeated, may reduce the connectivity between an application and a peripheral device. In addition, when the user uses a portable data processor such as a mobile terminal or a terminal shared among multiple users, it becomes difficult to ensure adequate information security with such manual entry, in which authentication information input by the user can be stolen by an unauthorized person secretly seeing or video recording the user's input.

Therefore, in terms of enhancing user convenience and connectivity and preventing authentication information from being stolen during the entry process, it may be preferred to use an authentication device, such as integrated circuit (IC) card or smart card, magnetic card, or read only memory (ROM) device, that retains authentication information and can perform data transmission without exposing the information to the outside.

Information stored in an authentication device is transmitted to a data processor through a data reader. By connecting an authentication device to a data reader, a user can eliminate the need for manual entry of information. A reader device is commonly provided on a peripheral device such as a multifunctional peripheral (MFP) connected to a data processor. In some cases, a peripheral device is located remote from a data processor connected thereto, causing inconvenience to a user operating the data processor. Such inconvenience can be avoided by installing an authentication library in a data processor, which serves as an interface between a reader device and the data processor, enabling a user to input information from the data processor.

### SUMMARY OF THE INVENTION

Exemplary aspects of the present invention are made in view of above-described circumstances, and provide a novel data processor capable of controlling access to a peripheral device requiring authentication.

Other exemplary aspects of the present invention provide a novel peripheral device that performs authentication by communicating with a data processor.

Other exemplary aspects of the present invention provide a novel recording medium having a computer program that causes a data processor to control access to a peripheral device requiring authentication.

In one exemplary embodiment, the novel data processor connected to a peripheral device via a network includes an interceptor, a controller, and a peripheral device manager. The interceptor is configured to intercept an access request for data stored in the peripheral device to issue a message indicating the interception and transmit the access request to the peripheral device. The controller is configured to determine, upon receipt of the message from the interceptor, whether to perform authentication based on configuration information of the peripheral device. Additionally, the controller is configured to determine, when authentication is to be performed, a mode for obtaining authentication data depending on whether an authentication library is installed. The peripheral device manager is configured to retrieve the configuration information from the peripheral device and transmit the configuration information to the controller.

In one exemplary embodiment, the novel peripheral device connected to a data processor via a network includes a database, a storage unit, a first access server, and a second access server. The database is configured to store data for processing by the data processor. The storage unit is configured to store configuration information indicating whether to perform authentication to limit access to the database. The first access server is configured to retrieve the configuration information from the storage unit and transmit the configuration information to the data processor in response to an access request transmitted therefrom. The second access server is configured to receive, when authentication is to be performed, authentication data from the data processor to permit access to the database. The authentication data is obtained in a mode determined by the data processor depending on whether an authentication library is installed therein.

In one exemplary embodiment, the novel recording medium has a computer program that causes a data processor to perform an authentication method including intercepting an access request for data stored in a peripheral device, determining whether to perform authentication based on configuration information of the peripheral device, transmitting the access request to the peripheral device, determining, when authentication is to be performed, a mode for obtaining authentication data depending on whether an authentication library is installed, and retrieving the configuration information from the peripheral device for determining whether to perform authentication.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating a data processor according to at least one exemplary embodiment of the present invention;

FIG. 2 is a block diagram illustrating a functional architecture of an exemplary authentication system using the data processor of FIG. 1;

FIG. 3 is a block diagram illustrating a functional architecture of another exemplary authentication system using the data processor of FIG. 1;

FIG. 4 is a block diagram illustrating a functional architecture of yet another exemplary authentication system using the data processor of FIG. 1;

FIG. 5 is a block diagram illustrating a functional architecture of still another exemplary authentication system using the data processor of FIG. 1;

FIG. 6 is a block diagram illustrating a functional architecture of still yet another exemplary authentication system using the data processor of FIG. 1;

FIG. 7 is a flowchart illustrating an example of an authentication process performed by the authentication system of FIG. 2;

FIG. 8 is a flowchart illustrating an example of an authentication process performed by the authentication system of FIG. 4;

FIG. 9 is a flowchart illustrating an example of an authentication process performed by the authentication system of FIG. 5; and

FIG. 10 is a flowchart illustrating an example of an authentication process performed by the authentication system of FIG. 6.

### DETAILED DESCRIPTION OF PREFERRED EMBODIMENTS

In describing preferred embodiments illustrated in the drawings, specific terminology is employed for the sake of clarity. However, the disclosure of the present invention is not intended to be limited to the specific terminology so selected, and it is to be understood that each specific element includes all technical equivalents that operate in a similar manner.

Referring now to the drawings, wherein like reference numerals designate identical or corresponding parts throughout the several views, exemplary embodiments of the present invention are described.

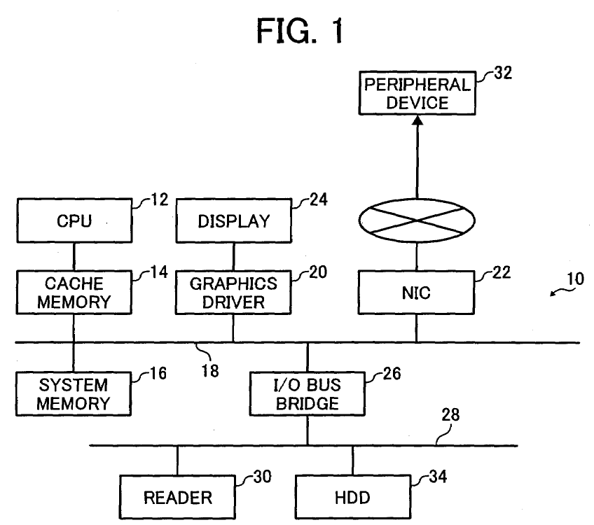

Referring to FIG. 1 of the drawings, a block diagram illustrating a data processor 10 according to at least one exemplary embodiment of the present invention is described.

The data processor 10 includes a central processing unit (CPU) 12, a cache memory 14, a system memory 16, a system bus 18, a graphics driver 20, a network interface card (NIC) 22, and a display 24. Further, the data processor 10 includes an I/O bus bridge 26, an I/O bus 28, a reader 30, and a hard disk drive (HDD) 34. In addition, the data processor 10 is connected to a peripheral device 32 via a network.

The data processor 10 may be a personal computer or a work station. In the data processor 10, the CPU 12 performs data processing by executing an application program. The cache memory 14 stores data used by the CPU 12 for quick access. The system memory 16 is a solid-state memory, such as random access memory (RAM) or dynamic random access memory (DRAM), allowing the CPU 12 to perform the data processing.

The system bus 18 connects the CPU 12, the cache memory 14, and the system memory 16 with other components such as the graphics driver 20 and the NIC 22. The graphics driver 20 is connected to the display 24, and receives information from the CPU 12 for output on the display 24. The NIC 22 is both a physical layer and data link layer device allowing the data processor 10 to communicate with the peripheral device 32 via the network.

The peripheral device 32 is any piece of equipment, e.g., a storage server or a multifunctional peripheral (MFP), executing transactions with the data processor 10 via the network.

The I/O bus bridge 26 connects the system bus 18 to the I/O bus 28. The I/O bus 28 is a bus interface such as peripheral component interconnect (PCI). The I/O bus 26 is connected to the HDD 34 via an interface, such as integrated drive electronics (IDE), advanced technology attachment (ATA), advanced technology attachment packet interface (ATAPI), small computer system interface (SCSI), or universal serial bus (USE) . The I/O bus 28 is also connected to the reader 30 via an interface, such as PCI, SCSI, or USE. The reader 30 is a data reader device such as a card reader, configured to obtain authentication data for controlling access to the peripheral device 32 from an application running on the data processor 10.

In addition, the CPU 12 may be any computer equipment including Pentium® to Pentium® 4, Pentiun®-compatible CPU, PowerPC®, and microprocessor without interlocked pipeline stages (MIPS), for example. The data processor 10 runs on a suitable operating system (OS) including MacOS®, Windows®, Windows® 200X servers, UNIX®, AIX®, and LINUX®, for example. The data processor 10 stores and executes an application program written in an object-oriented programming language such as C++, Visual C++, Visual Basic, Java®, which can run on any one of the aforementioned systems.

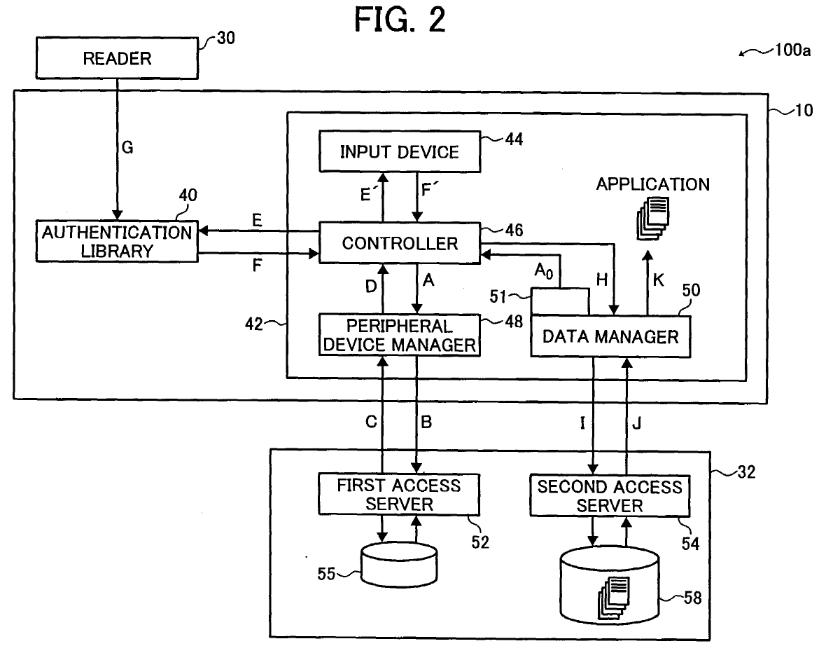

Referring now to FIG. 2, a block diagram illustrating a functional architecture of an authentication system 100a is described.

In FIG. 2, the authentication system 100a includes the data processor 10, the reader 30, and the peripheral device 32.

The data processor 10 includes an authentication library 40 and an authentication unit 42. The authentication unit 42 includes an input device 44, a controller 46, a peripheral device manager 48, a data manager 50, and an interceptor 51.

The peripheral device 32 includes a first access server 52, a second access server 54, a configuration memory 55, and a database 58.

The reader 30 has an interface such as USB to obtain data from a storage medium, not shown, including reprogrammable erasable computer memory, such as electrically erasable programmable read-only memory (EEPROM), erasable programmable read-only memory (EPROM), or flash memory.

In the authentication system 100a, the data processor 10 executes an application, which requests access to data stored in the peripheral device 32 (hereinafter referred to as “stored data”). The peripheral device 32 may require user authentication for access to the stored data. When the peripheral device 32 requires user authentication, a user provides information needed to gain authentication (hereinafter referred to as “authentication data”). The authentication data is provided to the peripheral device 32 through the data processor 10 for authentication. When the authentication data is validated, the data processor 10 retrieves the stored data for processing by the application. Such process is performed in accordance with information on settings related to user authentication by the peripheral device 32 (hereinafter referred to as “settings information 56”).

In the data processor 10, the authentication data is provided via the authentication library or the input device 44. The controller 46 controls access to the peripheral device 32. The peripheral device manager 48 and the data manager 50 each functions as an interface with the peripheral device 32. The interceptor 51 is included in the data manager 50 and serves to intercept a request from the application. Alternatively, the interceptor 51 may be placed at a suitable location in the authentication unit 42. The interceptor 51 may be implemented by an object module generated for managing the access request.

In the peripheral device 32, the configuration memory 55, being a storage unit such as an EEPROM, retains the settings information 56, and the database 58 retains the stored data. The settings information 56 includes the setting specifying whether the peripheral device 32 requires user authentication, and preferably includes a setting whether the peripheral device 32 supports an authentication scheme using the authentication library 40 (hereinafter referred to as “library-based authentication scheme”). Access to the configuration memory 55 and the database 58 is controlled by the first access server 52 and the second access server 54, respectively.

In the authentication system 100a, when the application submits an access request for the stored data, the interceptor 51 intercepts the request and notifies the controller 46 of receipt of the request (indicated by arrow “A₀”). Upon notification by the interceptor 51, the controller 46 sends an instruction (indicated by arrow “A”) to the peripheral device manager 48 to acquire the settings information 56 from the peripheral device 32. According to the instruction, the peripheral device manager 48 submits a request (indicated by arrow “B”) to the first access server 52.

In response to the request from the peripheral device manager 48, the first access server 52 retrieves settings information 56 from the configuration memory 55. The settings information 56 is transmitted to the peripheral device manager 48 (indicated by arrow “C”), then to the controller 46 (indicated by arrow “D”).

When the peripheral device 32 requires user authentication, the controller 46 determines whether the authentication library 40 is installed by consulting resource management data of the data processor 10, e.g., checking entries of a register memory or database. Depending on the result of the determination, the controller 46 sets an automatic mode or a manual mode for acquiring the authentication data.

When the authentication library 40 is installed, the authentication data is acquired in the automatic mode. In the automatic mode, the controller 46 submits an instruction (indicated by arrow “E”) to the authentication library 40 to acquire the authentication data. Receiving the instruction, the authentication library 40 acquires the authentication data from the reader 30 (indicated by arrow “G”) to transmit the acquired data to the controller 46 (indicated by arrow “F”).

When the authentication library 40 is not installed, the authentication data is acquired in the manual mode. In the manual mode, the controller 46 submits an instruction (indicated by arrow “E′”) to the input device 44 to acquire the authentication data, and prompts a user to input the authentication data by providing a dialog box on a display screen. Acquiring the authentication data, the input device 44 transmits the acquired data to the controller 46 (indicated by arrow “F′”).

Upon receipt of the authentication data, the controller 46 directs the interceptor 51 to transmit the intercepted request, and transmits the authentication data to the data manager 50 (indicated by arrow “H”). Then, the intercepted request and the authentication data are transmitted to the second access server 54 (indicated by arrow “I”).

The second access server 54 manages a user list for identifying authorized users, containing user identifiers and/or identification codes corresponding to the authentication data. When receiving the request and the authentication data from the data processor 10, the second access server 54 performs decoding when necessary, checks the authentication data for validity by comparison with data registered on the user list, and determines whether to permit the access to the database 58.

When the access is permitted by the peripheral device 32, the data manager 50 retrieves the stored data from the database 58 (indicated by arrow “J”), so that the application can perform processing and/or correction on the stored data in a suitable work area within the data processor 10 (indicated by arrow “K”). Following the completion of processing and/or correction, the application directs the data manager 50 to write the resulting data back to the database 58.

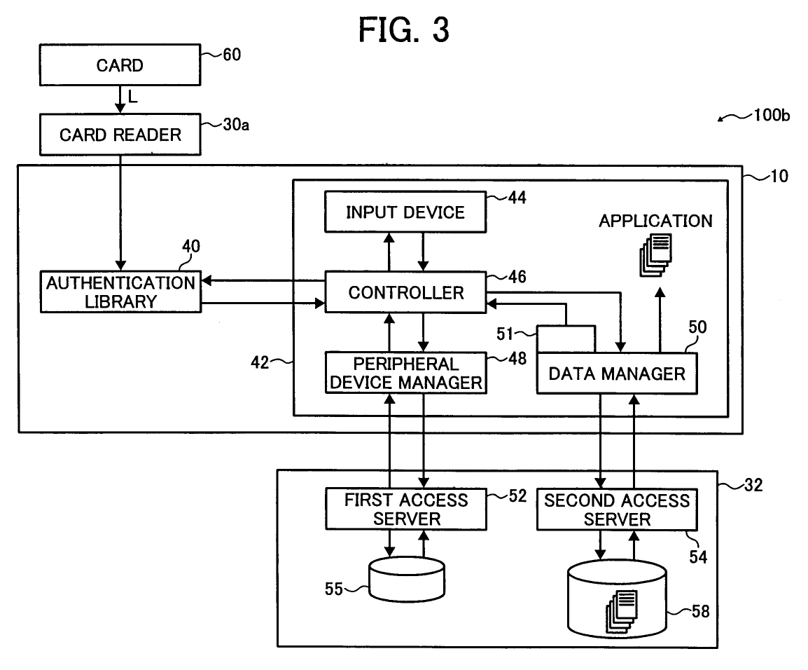

Referring now to FIG. 3, a block diagram illustrating a functional architecture of an authentication system 100b is described.

In FIG. 3, the authentication system 100b is designed in a similar manner to the authentication system 100a, except that the reader 30 is configured as a card reader 30a. The card reader 30a may be preferably an IC card reader, or may be any reader device, including a smart card reader, a magnetic card reader, a USB memory device, and a near field communication (NFC) device, capable of transferring information from a card 60. The card 60 stores the authentication data thereon, and may be any credit-card shaped storage device compatible with the card reader 30a, such as an integrated circuit card (ICC), a smart card, or a magnetic card. The authentication data is input to the card reader 30a from the card 60 (indicated by arrow “L”) with simple operations by a user.

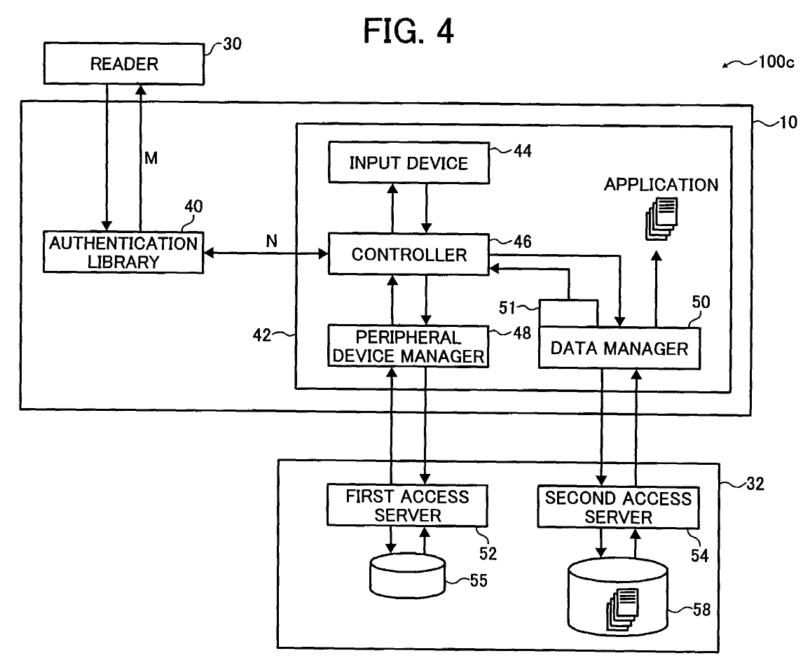

Referring now to FIG. 4, a block diagram illustrating a functional architecture of an authentication system 100c is described.

In FIG. 4, the authentication system 100c is designed in a similar manner to the authentication system 100a, except that the authentication library 40 monitors the reader 30 to determine whether the reader 30 is capable of providing the authentication data, and transmits the result of the determination to the controller 46.

In the authentication system 100c, the authentication library 40 determines whether the reader 30 is in a “connected” state or in a “disconnected” state (indicated by arrow “M”). The connected state represents a state that allows communication between the reader 30 and the data processor 10. The disconnected state represents a fault state, such as being disconnected from the data processor 10 or suffering a breakdown, that does not allow communication between the reader 30 and the data processor 10.

The authentication library 40 determines the state of the reader 30 when receiving an instruction from the authentication unit 42. The state of the reader 30 may be discerned by activating a module for inquiry. The inquiry module can be implemented with existing protocols such as internet control message protocol (ICMP) with ping commands, address resolution protocol (ARP), or simple network management protocol (SNMP).

Alternatively, the state of the reader 30 may be discerned by a reply command issued from the reader 30 in response to a request from the authentication library 40. The authentication library 40 submits a request for authentication data to the reader 30 in response to an instruction from the controller 46, issued when the peripheral device 32 requires user authentication. In addition, the authentication library 40 may be configured to submit a dummy request at a time during an initialization sequence of the data processor 10. In response to the request from the authentication library 40, the reader 30 returns a reply command, by which the authentication library 40 verifies that the reader 30 is in the connected state.

After discerning the state of the reader 30, the authentication library 40 transmits a message indicating the result of the determination (indicated by arrow “N”).

When the reader 30 is determined to be in the disconnected state, the controller 46 sets the manual mode for obtaining the authentication data. Consequently, the authentication unit 42 switches to the manual mode under conditions where the controller 46 determines that the authentication library 40 is not provided, and where the authentication library 40 determines that the reader 30 is in the disconnected state.

In the authentication system 100c, the authentication unit 42 can efficiently acquire authentication data by swiftly switching to the manual mode according to the state of the reader 30, thus enhancing smooth operation of the application running on the data processor 10.

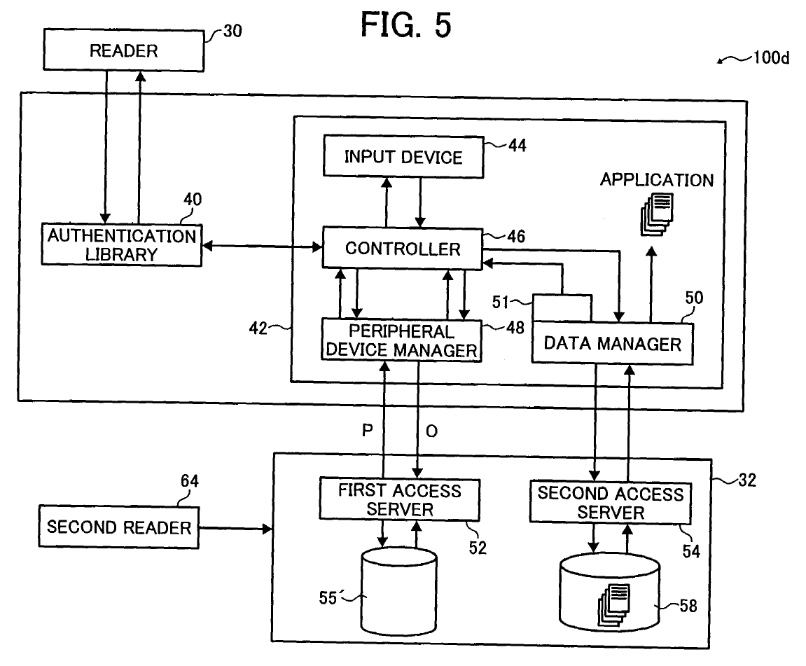

Referring now to FIG. 5, a block diagram illustrating a functional architecture of an authentication system 100d is described.

In FIG. 5, the authentication system 100d is designed in a similar manner to the authentication system 100c, except that the configuration memory 55′ stores information on hardware version installed in the peripheral device 32 (hereinafter referred to as “hardware information”, not shown) in addition to the settings information 56, and that the peripheral device 32 is provided with a second reader 64 connected thereto.

In the authentication system 100d, when receiving a request from the peripheral device manager 48 (indicated by arrow “O”), the first access server 52 accesses the configuration memory 55′ and retrieves the hardware information.

Then, the first access server 52 determines whether the peripheral device 32 supports the library-based authentication scheme according to the hardware information, and transmits a value indicating the result of the determination to the authentication unit 42 (indicated by arrow “P”). Alternatively, the first access server 52 may provide the hardware information to the authentication unit 42 so that the controller 46 may determine whether the peripheral device 32 supports the library-based authentication scheme. According to whether or not the peripheral device 32 supports the library-based authentication scheme, the authentication unit 42 switches to the automatic mode or the manual mode.

In the authentication system 100d, the peripheral device 32 may be implemented by an MFP, which can serve as a printer, a facsimile, and a copier provided with an operation panel allowing a user to manually input information. When a user operates the peripheral device 32 to gain authentication, authentication data may be entered from either the second reader 64 or the operation panel depending on the hardware version.

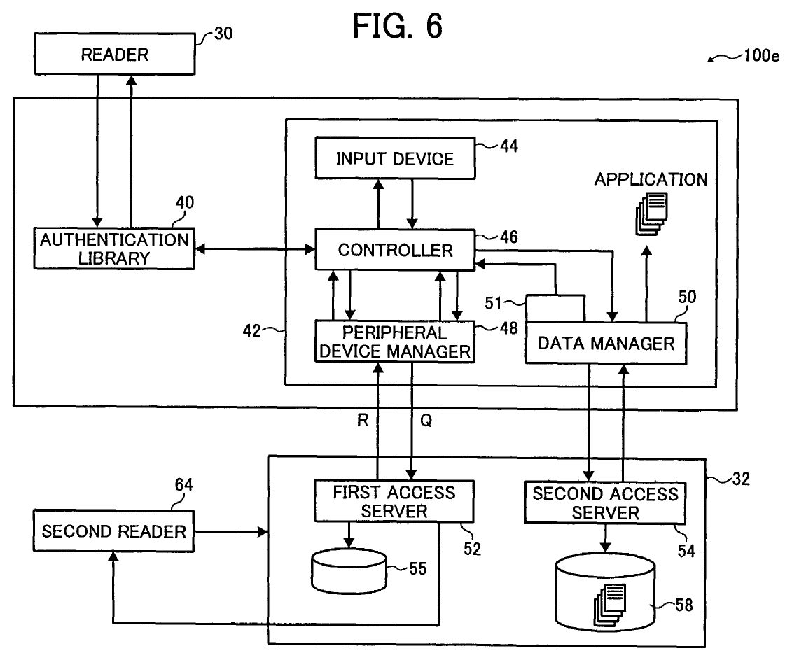

Referring now to FIG. 6, a block diagram illustrating a functional architecture of an authentication system 100e is described.

In FIG. 6, the authentication system 100e is designed in a similar manner to the authentication system 100c, except that the peripheral device 32 is provided with the second reader 64 connected thereto, and includes an internal mechanism, not shown, similar to the authentication library 40 and the authentication unit 42, by which the peripheral device 32 may perform user authentication without involving the data processor 10.

In the authentication system 100e, when receiving a request from the peripheral device manager 48 (indicated by arrow “Q”), the first access server 52 examines the settings information 56 to determine whether the peripheral device 32 supports the library-based authentication scheme. Upon determining that the peripheral device 32 supports the library-based authentication scheme, the first access server 52 determines whether the second reader 64 is connected to the peripheral device 32 and transmits a response to the peripheral device manager 48 (indicated by arrow “R”). Upon determining that the second reader 64 is connected to the peripheral device 32, the first access server 52 retrieves a value indicating that the reader 30 is to be used and directs the authentication unit 42 to set the automatic mode. Otherwise, the first access server 52 retrieves a value indicating that the reader 30 is not to be used and directs the authentication unit 42 to set the manual mode. The authentication unit 42 switches to the manual mode or the automatic mode according to the response from the first access server 52.

In the authentication system 100e, the automatic mode is used when the second reader 64 is usable in the peripheral device 32, and the manual mode is used when the second reader 64 is unusable in the peripheral device 32. As a result, a user can provide authentication data in a manner similar to that used in manipulating the peripheral device 32, which enhances ease of operation by avoiding user confusion upon entry of authentication data.

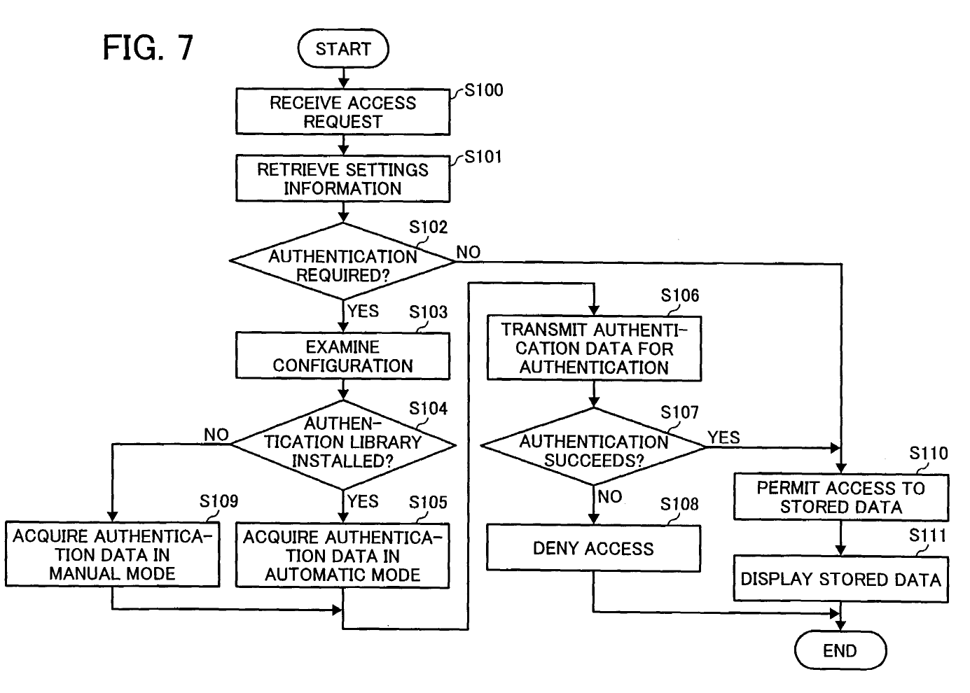

Referring now to FIG. 7, a flowchart illustrating an example of an authentication process performed by the authentication system 100a is described.

First, in step S100, an access request for the stored data is transmitted to the data manager 50 from an application, and the interceptor 51 informs the controller 46 of receipt of the access request. In step S101, the peripheral device manager 48 submits a request for the settings information 56 to the first access server 52. The first access server 52 retrieves the settings information 56 from the configuration memory 55, and the retrieved data is transmitted to the peripheral device manager 48, then to the controller 46.

In step S102, the controller 46 determines whether the peripheral device 32 requires user authentication according to the settings information 56. Upon determining that the peripheral device 32 requires user authentication (“YES” in step S102), the operation proceeds to step S103. Upon determining that the peripheral device 32 does not require user authentication (“NO” in step S102), the operation proceeds to step S110.

The controller 46 examines configuration information such as a registry database in step S103, and in step S104 determines whether the authentication library 40 is installed. When the authentication library 40 is installed (“YES” in step S104), the operation proceeds to step S105 where the controller 46 sets the automatic mode so that the authentication data is acquired from the reader 30. When the authentication library 40 is not installed (“NO” in step S104), the operation proceeds to step S109 where the controller 46 sets the manual mode so that the authentication data is acquired by user input.

Then, in step S106, the acquired authentication data is transmitted to the peripheral device 32. In step S107, the peripheral device 32 determines whether to permit access to the database 58 based on the authentication data. When the access is not permitted (“NO” in step S107), the operation proceeds to step S108 where the peripheral device 32 notifies the data processor 10 of an authentication failure, rejects the access request, and displays a message that the access is not permitted, after which the operation ends. When the access is permitted (“YES” in step S107), the operation continues to step S110.

In step S110, the peripheral device 32 notifies the data processor 10 that the access is permitted, causing the access request to be dispatched so that the data manager 50 reads data from the database 58 via the second access server 54. In step S111, the acquired data is displayed on a display screen of the data processor 10, allowing the user to manipulate the stored data, after which the operation ends.

By performing the authentication process of FIG. 7, the authentication system 100a enables automatic switching of the modes for inputting authentication data, enhancing the effect of the automatic mode which allows an application user to readily access the peripheral device 32 via the data processor 10.

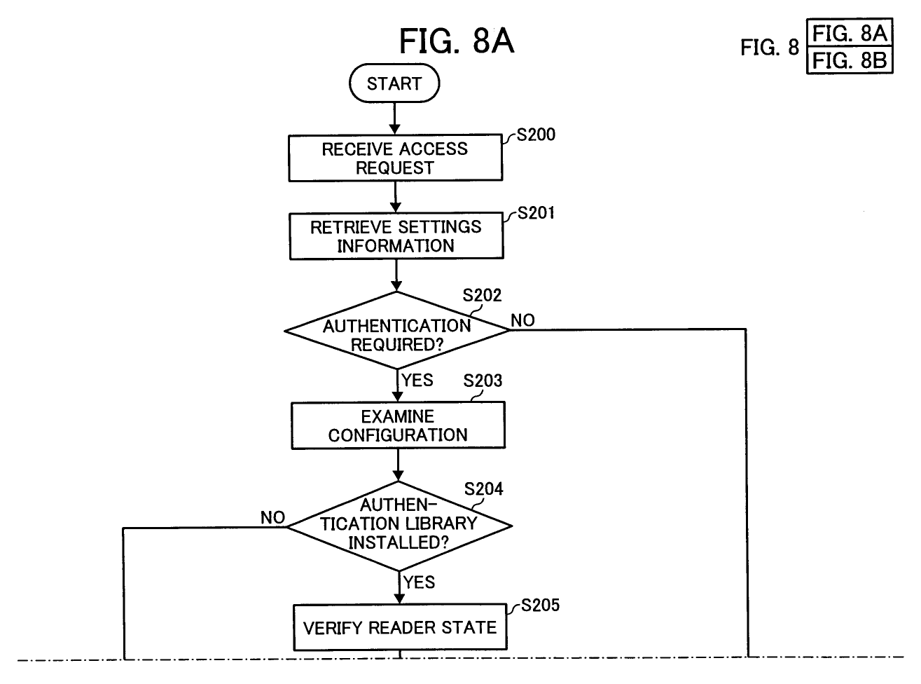

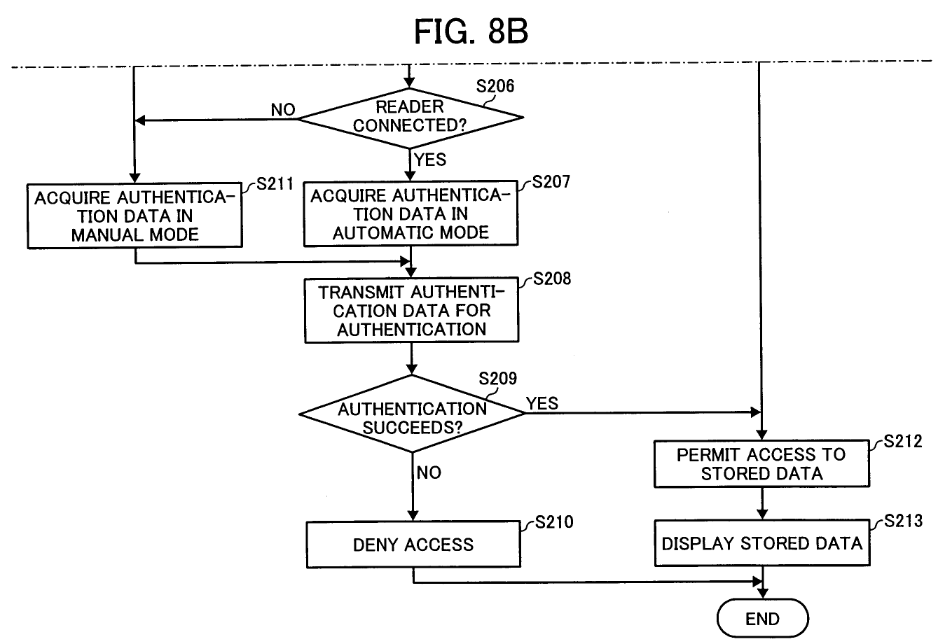

Referring now to FIG. 8, a flowchart illustrating an example of an authentication process performed by the authentication system 100c is described.

The authentication process of FIG. 8 is similar to the authentication process of FIG. 7, except for additional steps performed to determine whether the reader 30 is in the connected state before acquiring authentication data.

First, in step S200, an access request for the stored data is transmitted to the data manager 50 from an application, and the interceptor 51 informs the controller 46 of receipt of the access request. In step S201, the peripheral device manager 48 submits a request for the settings information 56 to the first access server 52. The first access server 52 retrieves the settings information 56 from the configuration memory 55, and the retrieved data is transmitted to the peripheral device manager 48, then to the controller 46.

In step S202, the controller 46 determines whether the peripheral device 32 requires user authentication according to the settings information 56. Upon determining that the peripheral device 32 requires user authentication (“YES” in step S202), the operation proceeds to step S203. Upon determining that the peripheral device 32 does not require user authentication (“NO” in step S202), the operation proceeds to step S212.

The controller 46 examines configuration information such as a registry database in step S203, and in step S204 determines whether the authentication library 40 is installed. When the authentication library 40 is installed (“YES” in step S204), the operation proceeds to step S205. When the authentication library 40 is not installed (“NO” in step S204), the operation proceeds to step S211.

The authentication library 40 verifies the state of the reader 30 in step S205, and determines whether the reader 30 is in the connected state or in the disconnected state in step S206. When the reader 30 is in the connected state (“YES” in step S206), the operation proceeds to step S207. When the reader 30 is in the disconnected state (“NO” in step S206), the operation proceeds to step S211.

In step S207, the controller 46 sets the automatic mode so that the authentication data is acquired from the reader 30. In step S211, the controller 46 sets the manual mode so that the authentication data is acquired by user input.

Then, in step S208, the acquired authentication data is transmitted to the peripheral device 32. In step S209, the peripheral device 32 determines whether to permit access to the database 58 based on the authentication data. When the access is not permitted (“NO” in step S209), the operation proceeds to step S210 where the peripheral device 32 notifies the data processor 10 of an authentication failure, rejects the access request, and displays a message that the access is not permitted, after which the operation ends. When the access is permitted (“YES” in step S209), the operation continues to step S212.

In step S212, the peripheral device 32 notifies the data processor 10 that the access is permitted, causing the access request to be dispatched so that the data manager 50 reads data from the database 58 via the second access server 54. In step S213, the acquired data is displayed on a display screen of the data processor 10, allowing the user to manipulate the stored data, after which the operation ends.

By performing the authentication process of FIG. 8, the authentication system 100c enables automatic switching of the modes for inputting authentication data, enhancing the effect of the automatic mode which allows an application user to readily access the peripheral device 32 via the data processor 10. Further, the authentication process of FIG. 8 prevents interruption due to the disconnected state of the reader 30, providing smooth operation of the application running on the data processor 10.

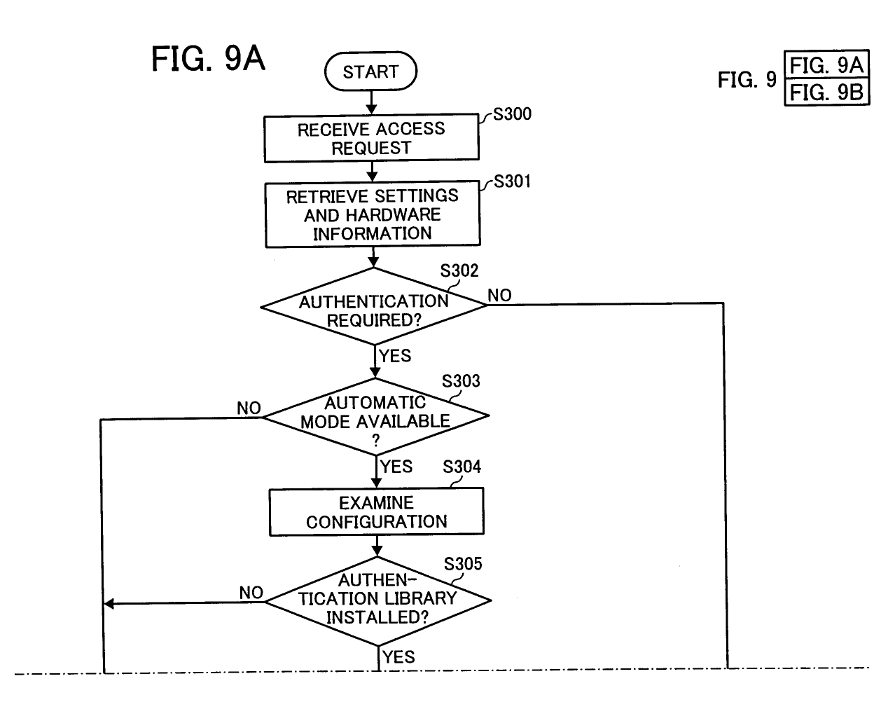

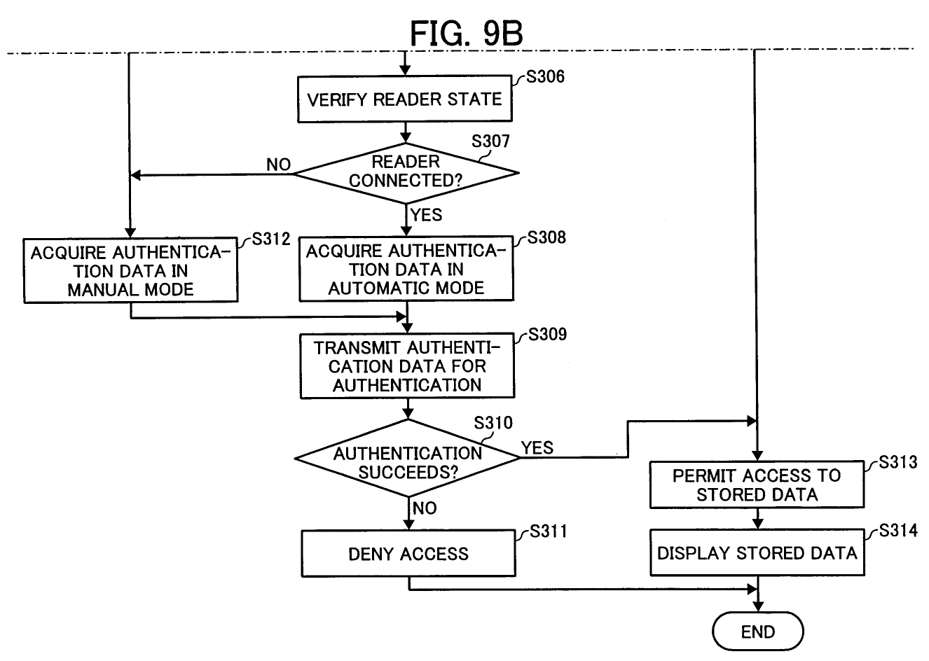

Referring now to FIG. 9, a flowchart illustrating an example of an authentication process performed by the authentication system 100d is described.

The authentication process of FIG. 9 is similar to the authentication process of FIG. 8, except for additional steps performed to determine whether the peripheral device 32 supports the library-based authentication scheme based on the hardware information.

First, in step S300, an access request for the stored data is transmitted to the data manager 50 from an application, and the interceptor 51 informs the controller 46 of receipt of the access request. In step S301, the peripheral device manager 48 submits a request for the settings information 56 and the hardware information to the first access server 52. The first access server 52 retrieves the settings information 56 and the hardware information from the configuration memory 55, and the retrieved data is transmitted to the peripheral device manager 48, then to the controller 46.

In step S302, the controller 46 determines whether the peripheral device 32 requires user authentication according to the settings information 56. Upon determining that the peripheral device 32 requires user authentication (“YES” in step S302), the operation proceeds to step S303. Upon determining that the peripheral device 32 does not require user authentication (“NO” in step S302), the operation proceeds to step S313.

In step S303, based on the hardware information, the controller 46 determines whether the peripheral device 32 supports the library-based authentication scheme, i.e., whether the automatic mode is available. When the automatic mode is determined to be available (“YES” in step S303), the operation proceeds to step S304. When the automatic mode is determined to be unavailable (“NO” in step S303), the operation proceeds to step S312.

The controller 46 examines configuration information such as a registry database in step S304, and in step S305 determines whether the authentication library 40 is installed. When the authentication library 40 is installed (“YES” in step S305), the operation proceeds to step S306. When the authentication library 40 is not installed (“NO” in step S305), the operation proceeds to step S312.

The authentication library 40 verifies the state of the reader 30 in step S306, and determines whether the reader 30 is in the connected state or in the disconnected state in step S307. When the reader 30 is in the connected state (“YES” in step S307), the operation proceeds to step S308. When the reader 30 is in the disconnected state (“NO” in step S307), the operation proceeds to step S312. In step S308, the controller 46 sets the automatic mode so that the authentication data is acquired from the reader 30. In step S312, the controller 46 sets the manual mode so that the authentication data is acquired by user input.

Then, in step S309, the acquired authentication data is transmitted to the peripheral device 32. In step S310, the peripheral device 32 determines whether to permit access to the database 58 based on the authentication data. When the access is not permitted (“NO” in step S310), the operation proceeds to step S311 where the peripheral device 32 notifies the data processor 10 of an authentication failure, rejects the access request, and displays a message that the access is not permitted, after which the operation ends. When the access is permitted (“YES” in step S310), the operation continues to step S313.

In step S313, the peripheral device 32 notifies the data processor 10 that the access is permitted, causing the access request to be dispatched so that the data manager 50 reads data from the database 58 via the second access server 54. In step S314, the acquired data is displayed on a display screen of the data processor 10, allowing the user to manipulate the stored data, after which the operation ends.

By performing the authentication process of FIG. 9, the authentication system 100d enables automatic switching of the modes for inputting authentication data, enhancing the effect of the automatic mode which allows an application user to readily access the peripheral device 32 via the data processor 10. Further, the authentication process of FIG. 9 prevents interruption that occurs when the configuration of the peripheral device 32 is incompatible with the library-based authentication scheme, providing smooth operation of the application running on the data processor 10.

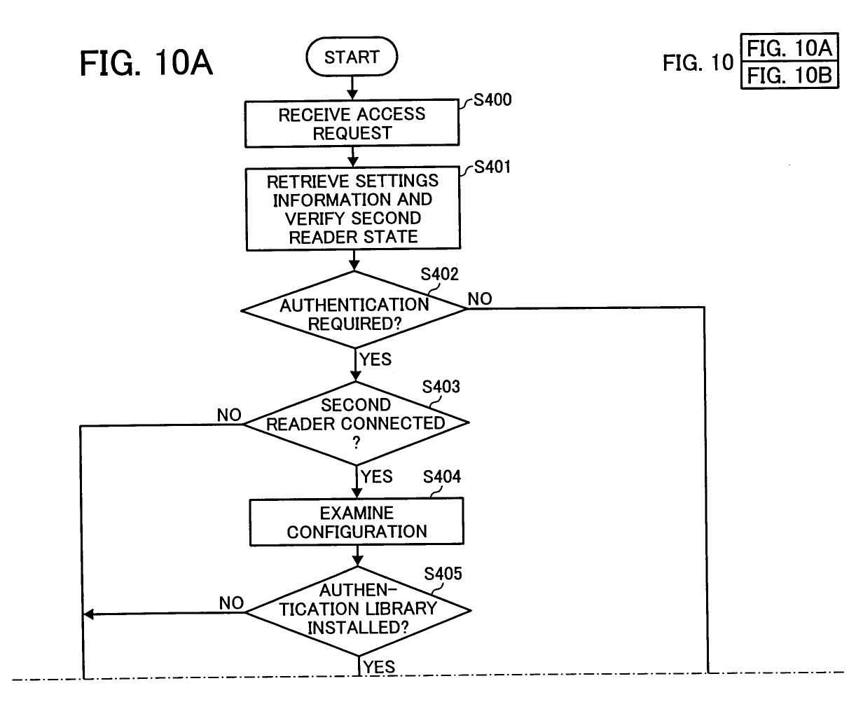

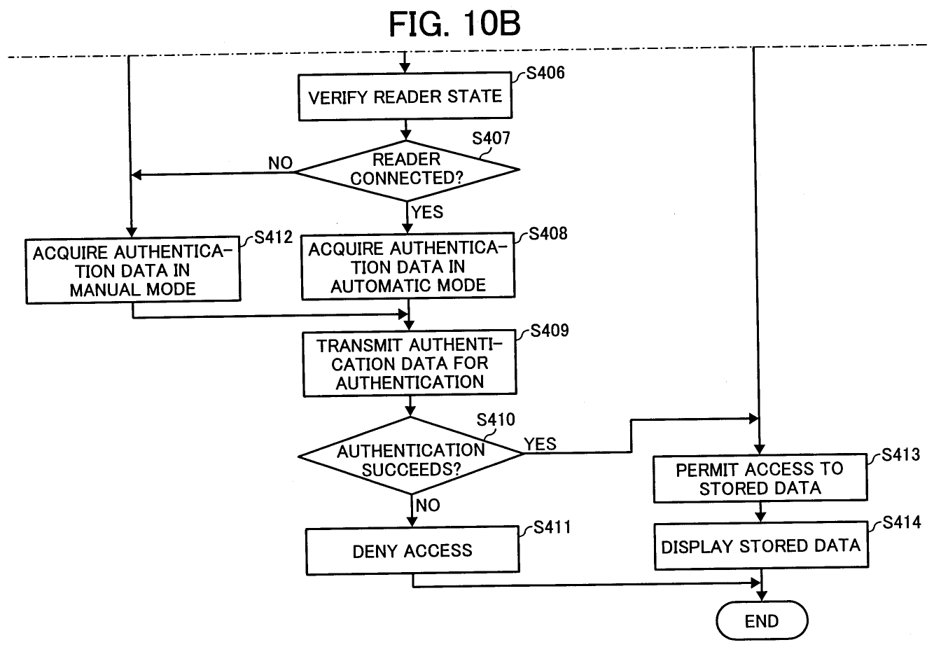

Referring now to FIG. 10, a flowchart illustrating an example of an authentication process performed by the authentication system 100e is described.

The authentication process of FIG. 10 is similar to the authentication process of FIG. 9, except for steps performed to determine whether to use the automatic mode based on the state of the peripheral device 32.

First, in step S400, an access request for the stored data is transmitted to the data manager 50 from an application, and the interceptor 51 informs the controller 46 of receipt of the access request. In step S401, the peripheral device manager 48 submits a request for the settings information 56 to the first access server 52. The first access server 52 retrieves the settings information 56 from the configuration memory 55, and the retrieved data is transmitted to the peripheral device manager 48, then to the controller 46. Meanwhile, the peripheral device 32 verifies the state of the second reader 64.

In step S402, the controller 46 determines whether the peripheral device 32 requires user authentication according to the settings information 56. Upon determining that the peripheral device 32 requires user authentication (“YES” in step S402), the operation proceeds to step S403. Upon determining that the peripheral device 32 does not require user authentication (“NO” in step S402), the operation proceeds to step S413.

In step S403, the controller 46 determines whether to use the automatic mode based on whether the second reader 64 is connected to the peripheral device 32. When the second reader 64 is connected to the peripheral device 32 (“YES” in step S403), the automatic mode is determined to be usable and the operation proceeds to step S404. When the second reader 64 is not connected to the peripheral device 32 (“NO” in step S403), the automatic mode is determined to be unusable and the operation proceeds to step S412.

The controller 46 examines configuration information such as a registry database in step S404, and in step S405 determines whether the authentication library 40 is installed. When the authentication library 40 is installed (“YES” in step S405), the operation proceeds to step S406. When the authentication library 40 is not installed (“NO” in step S405), the operation proceeds to step S412.

In step S406, the authentication library 40 determines whether the reader 30 is in the connected state or in the disconnected state. When the reader 30 is in the connected state (“YES” in step S407), the operation proceeds to step S408. When the reader 30 is in the disconnected state (“NO” in step S407), the operation proceeds to step S412. In step S408, the controller 46 sets the automatic mode so that the authentication data is acquired from the reader 30. In step S412, the controller 46 sets the manual mode so that the authentication data is acquired by user input.

Then, in step S409, the acquired authentication data is transmitted to the peripheral device 32. In step S410, the peripheral device 32 determines whether to permit access to the database 58 based on the authentication data. When the access is not permitted (“NO” in step S410), the operation proceeds to step S411 where the peripheral device 32 notifies the data processor 10 of an authentication failure, rejects the access request, and displays a message that the access is not permitted, after which the operation ends. When the access is permitted (“YES” in step S410), the operation continues to step S413.

In step S413, the peripheral device 32 notifies the data processor 10 that the access is permitted, causing the access request to be dispatched so that the data manager 50 reads data from the database 58 via the second access server 54. Then, in step S414, the acquired data is displayed on a display screen of the data processor 10, allowing the user to manipulate the stored data, after which the operation ends.

By performing the authentication process of FIG. 10, the authentication system 100e enables automatic switching of the modes for inputting authentication data, enhancing the effect of the automatic mode which allows an application user to readily access the peripheral device 32 via the data processor 10. Further, the authentication process of FIG. 10 enhances ease of operation by avoiding user confusion upon entry of authentication data, which may occur when the peripheral device 32 is compatible with the library-based authentication scheme.

As can be appreciated by those skilled in the art, numerous additional modifications and variations are possible in light of the above teachings. It is therefore to be understood that, within the scope of the appended claims, the disclosure of this present invention may be practiced otherwise than as specifically described herein.

Further, elements and/or features of different exemplary embodiments may be combined with each other and/or substituted for each other within the scope of this disclosure and appended claims.

Still further, any one of the above-described and other example features of the present invention may be embodied in the form of an apparatus, method, system, computer program and computer program product. For example, the aforementioned methods may be embodied in the form of a system or device, including, but not limited to, any of the structure for performing the methodology illustrated in the drawings.

Even further, any of the aforementioned methods may be embodied in the form of a program, written in an object-oriented or legacy programming language, such as C, C++, or Java. The program may be stored on a computer readable medium and is adapted to perform any one of the aforementioned methods when run on a computer device (a device including a processor). Thus, the storage medium or computer readable medium is adapted to store information and is adapted to interact with a data processing facility or computer device to perform the method of any of the above mentioned embodiments.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A data processor connected to a peripheral device via a network, comprising:
an interceptor configured to intercept an access request for data stored in the peripheral device to issue a message indicating the interception, and to transmit the access request to the peripheral device;
a controller configured to determine, upon receipt of the message from the interceptor, whether to perform authentication based on configuration information of the peripheral device, and to determine, when authentication is to be performed, a mode for obtaining authentication data depending on whether an authentication library is installed; and
a peripheral device manager configured to retrieve the configuration information from the peripheral device and transmit the configuration information to the controller.

2. The data processor according to claim 1, wherein the authentication library acquires the authentication data through a data reader connected thereto, the authentication data being stored in one of an integrated circuit card, a smart card, a magnetic card, and a read only memory device.

3. The data processor according to claim 2, wherein the authentication library determines whether or not the data reader is capable of providing the authentication data.

4. The data processor according to claim 1, wherein the interceptor transmits the access request with the authentication data when authentication is to be performed and otherwise transmits only the access request for accessing the stored data.

5. A peripheral device connected to a data processor via a network, comprising:
a database configured to store data for processing by the data processor;
a storage unit configured to store configuration information indicating whether to perform authentication to limit access to the database;
a first access server configured to retrieve the configuration information from the storage unit and transmit the configuration information to the data processor in response to an access request transmitted therefrom; and
a second access server configured to receive, when authentication is to be performed, authentication data from the data processor to permit access to the database, the authentication data being obtained in a mode determined by the data processor depending on whether an authentication library is installed therein.

6. The peripheral device according to claim 5, wherein the configuration information includes one of hardware version and a set value each indicating whether the peripheral device is compatible with the authentication library, and the authentication data is obtained in one of an automatic mode and a manual mode in accordance with the configuration information.

7. The peripheral device according to claim 5, further comprising a second data reader connected thereto and capable of providing the authentication data, wherein the second data reader is unused to obtain the authentication data for determining whether to permit access to the database from the data processor.

8. The peripheral device according to claim 7, further comprising a user interface configured to allow a user to manually input the authentication data, wherein when the second data reader is unusable, the first access server directs the data processor to obtain the authentication data in a manual mode.

9. A recording medium having a computer program that causes a data processor to perform an authentication method comprising:
intercepting an access request for data stored in a peripheral device;
upon interception of the access request, determining whether to perform authentication based on configuration information of the peripheral device;
transmitting the access request to the peripheral device;
determining, when authentication is to be performed, a mode for obtaining authentication data depending on whether an authentication library is installed; and
retrieving the configuration information from the peripheral device for determining whether to perform authentication.

10. The recording medium according to claim 9, wherein the authentication library acquires the authentication data through a data reader connected thereto, the authentication data being stored in one of an integrated circuit card, a smart card, a magnetic card, and a read only memory device.

11. The recording medium according to claim 10, wherein the authentication library determines whether or not the data reader is capable of providing the authentication data.

12. The recording medium according to claim 11, wherein the transmission transmits the access request with the authentication data when authentication is to be performed and otherwise transmits only the access request for accessing the stored data.
